(19) United States
(12) Patent Application Publication
(10) Pub. No.: US 2024/0286628 A1
(43) Pub. Date: Aug. 29, 2024

(54) OBJECT RECOGNITION DEVICE AND PROGRAM

(71) Applicants: DENSO CORPORATION, Kariya-city (JP); J-QuAD DYNAMICS INC., Tokyo (JP)

(72) Inventors: Keita SUGIURA, Kariya-city (JP); Yasuyuki MIYAKE, Kariya-city (JP); Naotsugu SHIMIZU, Kariya-city (JP); Junzoh TSUCHIYA, Kariya-city (JP); Masafumi IBUSHI, Kariya-city (JP); Seiya FUJITSU, Kariya-city (JP); Hiroyuki ISHIMORI, Kariya-city (JP)

(21) Appl. No.: 18/656,327

(22) Filed: May 6, 2024

Related U.S. Application Data
(63) Continuation of application No. PCT/JP2022/038186, filed on Oct. 13, 2022.

(30) Foreign Application Priority Data
Nov. 8, 2021 (JP) 2021-182187

(51) Int. Cl. B60W 50/06; G01S 7/292; G01S 13/04; G01S 13/931

(52) U.S. Cl. CPC B60W 50/06; G01S 7/292; G01S 13/04; G01S 13/931; B60W 2420/408; B60W 2554/802; G01S 2013/9322

(57) ABSTRACT

An object recognition device is applied to a vehicle having a range sensor that transmits a probe wave and receives the reflected wave of the probe wave. The object recognition device is configured to recognize an object behind the own vehicle based on detection information of the range sensor. The object recognition device includes a tow determining unit configured to determine whether a towed vehicle is coupled to a rear of the own vehicle, and a changing unit configured to, in response to determining that the towed vehicle is coupled to the rear of the own vehicle, change how the range sensor detects an object to suppress reception of the reflected wave caused by presence of the towed vehicle.

### CROSS-REFERENCE TO RELATED APPLICATION

The present application is a continuation application of International Application No. PCT/JP2022/038186, filed on Oct. 13, 2022, which claims priority to Japanese Patent Application No. 2021-182187, filed on Nov. 8, 2021. The contents of these applications are incorporated herein by reference in their entirety.

### BACKGROUND

### Technical Field

The present disclosure relates to an object recognition device and a program.

### Background Art

A known object recognition device of this kind is applied to a vehicle provided with a range sensor that transmits probe waves and receives the reflected waves of the probe waves. The object recognition device recognizes objects around the vehicle based on the detection information from the range sensor.

### SUMMARY

In the present disclosure, provided is an object recognition device as the following.

The object recognition device is applied to a vehicle having a range sensor that transmits a probe wave and receives a reflected wave of the probe wave. The object recognition device includes: a tow determining unit configured to determine whether a towed vehicle is coupled to a rear of the own vehicle; and a changing unit configured to, in response to determining that the towed vehicle is coupled to the rear of the own vehicle, change how the range sensor detects an object to suppress reception of the reflected wave caused by presence of the towed vehicle.

### BRIEF DESCRIPTION OF THE DRAWINGS

The foregoing and other objects, features, and advantages of the present disclosure will be more clarified by the following detailed descriptions with reference to the accompanying drawings. In the drawings,

FIG. 1 is an overall configuration view of an object recognition system according to a first embodiment.

FIG. 2 is a diagram showing detection areas around the own vehicle.

FIG. 3 is a diagram showing the state in which a trailer is towed.

FIGS. 4A to 4B are a joint diagram showing an example of a trailer.

FIGS. 5A to 5D are a joint explanatory diagram regarding the settings of the transmission power of a range sensor.

FIG. 6 is an explanatory diagram regarding the settings of the transmission power of a range sensor.

FIGS. 7A to 7B are a joint diagram showing detection areas of a range sensor.

FIG. 8 is a diagram showing detection areas of a range sensor.

FIG. 9 is a flowchart showing a process of changing how sensor detection is performed.

FIG. 10 is a diagram showing a state where dummy objects are recognized around the own vehicle.

FIG. 11 is a flowchart showing a process of changing how sensor detection is performed according to a fourth embodiment.

### DETAILED DESCRIPTION OF THE PREFERRED EMBODIMENTS

### [PTL 1] JP 2016-85567 A

As described in PTL 1, a towed vehicle may be coupled to the rear of the own vehicle. In such a case, due to the presence of the towed vehicle, multipath waves may be generated that pass through a plurality of reflection points and are received by the range sensor as reflected waves. Multipath waves are reflected waves that are unnecessary for the range sensor to detect objects. If the range sensor receives multipath waves, objects behind the own vehicle may not be able to be correctly recognized.

The present disclosure has been made in view of the above circumstances, and a main purpose thereof is to provide an object recognition device and program capable of correctly recognizing objects behind the own vehicle in a situation where a towed vehicle is coupled to the rear of the own vehicle.

The present disclosure provides an object recognition device applied to a vehicle having a range sensor that transmits a probe wave and receives a reflected wave of the probe wave and configured to recognize an object behind an own vehicle based on detection information of the range sensor, the object recognition device including: a tow determining unit configured to determine whether a towed vehicle is coupled to a rear of the own vehicle; and a changing unit configured to, in response to determining that the towed vehicle is coupled to the rear of the own vehicle, change how the range sensor detects an object to suppress reception of the reflected wave caused by presence of the towed vehicle.

According to the present disclosure, if it is determined that a towed vehicle is coupled to the rear of the own vehicle, how the range sensor detects an object is changed to suppress reception of reflected waves caused by the presence of the towed vehicle. This suppresses the reception of multipath waves, which are reflected waves unnecessary for recognizing objects when objects behind the own vehicle are to be recognized. As a result, in a situation where the towed vehicle is coupled to the rear of the own vehicle, objects behind the own vehicle can be correctly recognized.

### First Embodiment

A first embodiment for putting an object recognition device according to the present disclosure into practice will be described with reference to the drawings. An object recognition system 10 according to the present embodiment is mounted to an own vehicle to recognize objects (vehicles, pedestrians, on-road obstacles, and the like) around the own vehicle.

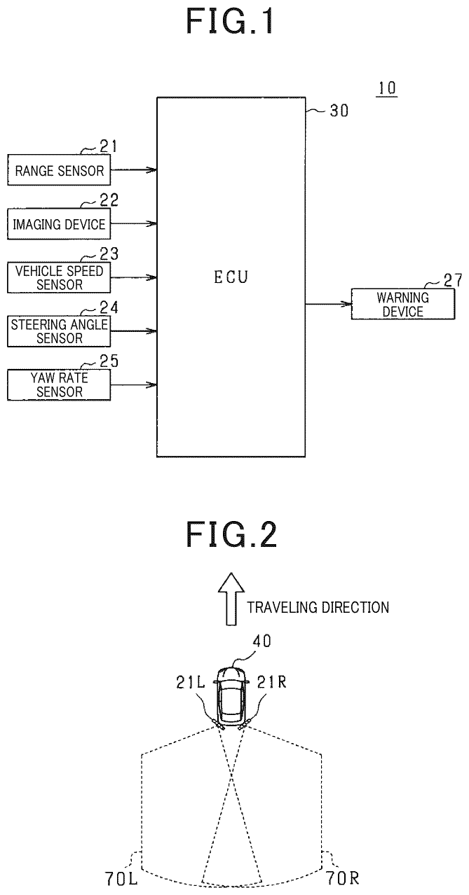

As shown in FIG. 1, the object recognition system 10 according to the present embodiment includes range sensors 21, an imaging device 22, a vehicle speed sensor 23, a steering angle sensor 24, a yaw rate sensor 25, and an ECU 30 as an object recognition device.

The range sensors 21 are, for example, known millimeter wave radars that use a high frequency signal in the millimeter waveband as transmission waves. The range sensors 21 are provided at the rear end of the own vehicle. The area inside a predetermined detection angle of each range sensor 21 is defined as a detection area, and detection information is obtained such as the distances to objects within the detection area and their azimuths. Specifically, each range sensor 21 transmits probe waves at predetermined intervals, and receives reflected waves with a plurality of antennas. The range sensors 21 calculate the distance to an object from the time at which the probe waves were transmitted and the time at which the reflected waves were received. The range sensors 21 also calculate the relative speed of the object based on the frequencies of the reflected waves from the object, which vary due to the Doppler effect. In addition, the range sensors 21 calculate the azimuth of the object from the phase difference(s) between the reflected waves received by the plurality of antennas. The range sensors 21 receive the reflected waves reflected by objects, and sequentially outputs to the ECU 30 pieces of detection information based on the received signals.

Instead of millimeter wave radars, the object recognition system 10 may include, as the range sensors 21, ultrasonic sensors, LIDARs (Light Detection and Ranging/Laser Imaging Detection and Ranging), or other sensors that transmit probe waves.

The imaging device 22 may be a single lens camera such as a CCD camera, a CMOS image sensor, or a near-infrared camera, or a stereo camera. The own vehicle may be provided with only one imaging device 22 or a plurality of imaging devices 22. The imaging device 22 may be, for example, attached to the vehicle at a predetermined level and at the center of the vehicle in the lateral direction. The imaging device 22 captures images, which are converted to have a bird's eye viewpoint, of the region extending behind the vehicle over a predetermined angular range to acquire captured images as detection information. The imaging device 22 sequentially outputs the acquired captured images to the ECU 30.

The vehicle speed sensor 23 is a sensor that detects the traveling speed of the own vehicle. For example, a wheel speed sensor that can detect the rotational speed of the wheels can be used. The vehicle speed sensor 23 outputs a traveling speed signal according to the traveling speed of the own vehicle to the ECU 30.

The steering angle sensor 24 is a sensor that detects the steering angle of the steering wheel, and is attached to, for example, the steering rod of the vehicle. The steering angle sensor 24 outputs a steering angle signal to the ECU 30 in response to a change in the steering angle of the steering wheel caused by the driver operating it.

The yaw rate sensor 25 is a sensor that detects the turning angular velocity of the own vehicle and outputs a yaw rate signal corresponding to the turning angular velocity of the own vehicle to the ECU 30.

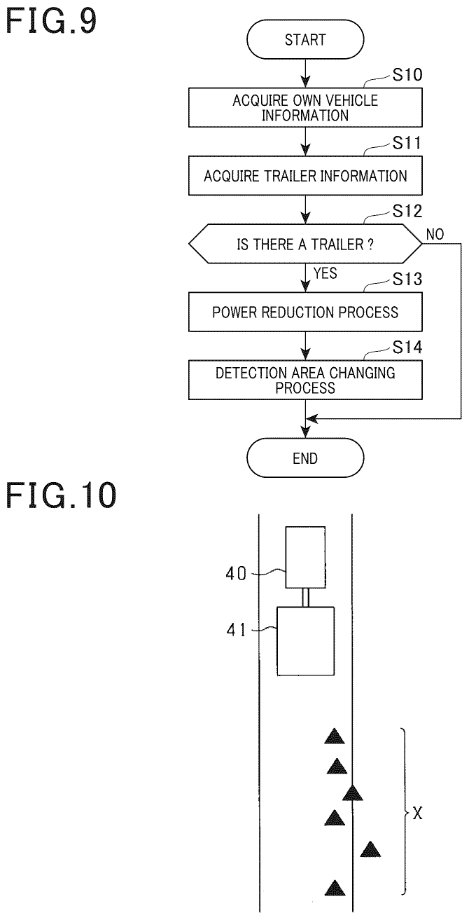

The functions provided by the ECU 30 can be provided by software recorded in a physical memory device and a computer that executes the software, only software, only hardware, or a combination thereof. For example, in the case where the ECU 30 is provided by electronic circuits, which are hardware, they can be provided using a digital circuit including a number of logic circuits or an analog circuit. For example, the ECU 30 executes programs stored in a non-transitory tangible storage medium that is a storage included in the ECU 30 itself. The programs include, for example, a program for the process shown in FIG. 9 and other parts. When the programs are executed, methods corresponding to the programs are carried out. The storage may be, for example, a nonvolatile memory. Note that the programs stored in the storage can be updated via a network such as the Internet, for example.

The ECU 30 recognizes objects behind an own vehicle 40 based on detection information from the range sensors 21 and the imaging device 22. For example, as shown in FIG. 2, one range sensor 21 is installed on each of the left and right side of the rear end of the own vehicle 40 to acquire the detection information on objects behind and on the left and right rear of the own vehicle 40. A range sensor 21L installed on the left side of the rear end of the own vehicle 40 acquires detection information on objects present in a detection area 70L. A range sensor 21R installed on the right side of the rear end of the own vehicle 40 acquires detection information on objects present in a detection area 70R. The ECU 30 recognizes objects on the left and right rear of the own vehicle 40 based on the detection information from the range sensors 21L and 21R.

The ECU 30 causes a warning device 27 to notify the driver based on the recognition results about objects behind the own vehicle 40. The warning device 27 may be, for example, an audible notification device such as a speaker or a buzzer, or a visual notification device such as a display or a warning light installed on the interior of the own vehicle 40. For example, when another vehicle approaches the own vehicle 40 from behind in a lane adjacent to the lane in which the own vehicle 40 is traveling, the ECU 30 may cause the warning device 27 to issue a notification as appropriate.

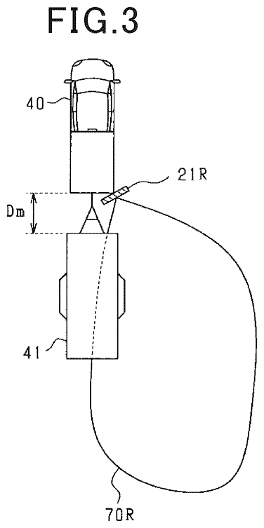

Meanwhile, a towed vehicle may be coupled to the rear of the own vehicle 40. In this embodiment, it is assumed that a trailer 41 for transporting cargo or the like is coupled to the rear of the own vehicle 40 as a towed vehicle. FIG. 3 shows the state in which it is towed. In FIG. 3, only the detection area 70R of the right range sensor 21R is shown between the detection areas 70L and 70R of the range sensors 21L and 21R. In the following, the range sensor 21R and the detection area 70R on the right will be described as examples and will be referred to as the range sensor 21 and the detection area 70.

In the state shown in FIG. 3, the trailer 41 and a part of the detection area 70 of the range sensor 21 overlap. Therefore, the trailer 41 is in the detection area 70 of the range sensor 21, and reflected waves caused by the presence of the trailer 41 may be input to the range sensor 21. Note that, instead of the trailer 41, another vehicle such as a disabled vehicle may be coupled to the rear of the own vehicle 40 as the towed vehicle.

The reflected waves caused by the presence of the trailer 41 include multipath waves that pass through a plurality of reflection points between the transmission of the probe waves and the reception of their reflected waves. Compared to direct waves that travel back and forth between the range sensor 21 and the object by taking the shortest path, multipath waves have an increased number of reflection points and therefore travel a longer distance from the transmission of the probe waves to the reception of their reflected waves. As a result, when the range sensor 21 receives multipath waves, the distance to the object may be calculated to be longer than the actual distance to the object. Further, when the range sensor 21 receives multipath waves, detection information on objects that are actually not present (dummy objects) may be acquired. In short, multipath waves are reflected waves that are unnecessary to correctly detect objects, and if the range sensor 21 receives multipath waves, objects behind the own vehicle 40 may not be able to be correctly recognized.

To address this, the ECU 30 determines whether the trailer 41 is coupled to the rear of the own vehicle 40, and if it is determined that the trailer 41 is coupled, the ECU 30 changes how the range sensor 21 detects objects as appropriate to suppress reception of the reflected waves caused by the presence of the trailer 41. Whether the trailer 41 is coupled may be determined based on a signal input by the user or a detection signal from a sensor mounted on the vehicle or the like. For example, a tow sensor for detecting the presence of a towed object is provided on a tow hitch attached to the rear of the own vehicle 40, and the ECU 30 determines whether the trailer 41 is coupled based on a signal from the tow sensor. Alternatively, the ECU 30 determines that the trailer 41 is coupled when, while the own vehicle 40 is traveling, at least one of the range sensor 21 and the imaging device 22 detects an object behind the own vehicle, and the distance to the object remains within a predetermined distance.

As processes for changing how the range sensor 21 detects objects, the ECU 30 performs a power reduction process to reduce the power used to transmit the probe waves from the range sensor 21, and a detection area changing process to change the detection area 70 of the range sensor 21 towards the side where the trailer 41 is not present. In this embodiment, the ECU 30 reduces the power used to transmit probe waves from the range sensor 21 in the power reduction process. By reducing the transmission power of the range sensor 21, the intensity of the reflected waves caused by the presence of the trailer 41 decreases. Further, the range sensor 21 may use, for example, an electronic method, a directivity switching method, or a mechanical scanning method to scan the detection area 70 with probe waves. The ECU 30 changes the detection area 70 by adjusting the region scanned with the probe waves by the range sensor 21 in the detection area changing process. These power reduction process and detection area changing process suppress the generation of reflected waves caused by the presence of the trailer 41.

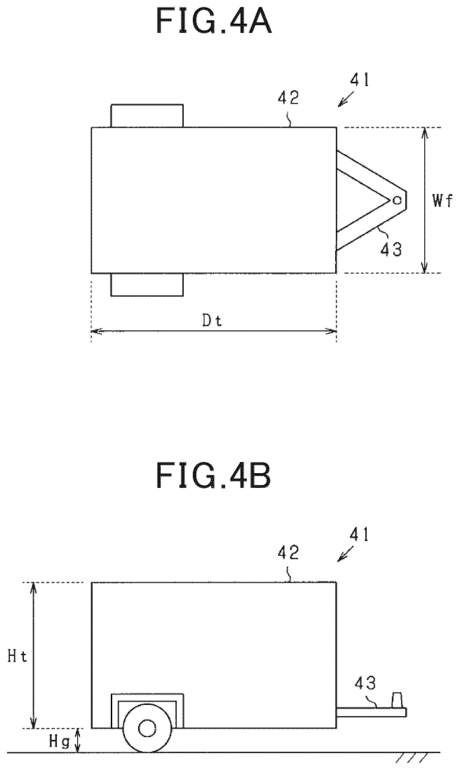

The power reduction process for the range sensor 21 in a state where the trailer 41 is being towed behind the own vehicle 40 will be described in detail below. FIGS. 4A and 4B show an example of the trailer 41. The trailer 41 includes a trailer body 42 with wheels, and a coupling part 43 extending forward from the trailer body 42 and configured to be coupled to the rear of the own vehicle 40. In FIGS. 4A and 4B, the width of the front of the trailer is denoted by Wf, the longitudinal length from the tip to the rear end of the trailer is denoted by Dt, the top height from the road surface to the top of the trailer is denoted by Ht, and the minimum ground clearance from road surface to the bottom of the trailer is denoted by Hg. The longitudinal length Dt of the trailer 41 may be the longitudinal length of the trailer body 42 or the length from the tip of the coupling part 43 to the rear end of the trailer body 42.

Note that the trailer 41 can be of any type, and the trailer 41 may be a trailer with a flat front face, a V-nose trailer with a V-shaped tip, or a trailer in which the vehicle coupling part and the cargo bed part can be separated.

The ECU 30 acquires form information on the form of the trailer 41, and executes the power reduction process of the range sensor 21 based on this form information. In this case, the ECU 30 acquires at least one of the width Wf, the longitudinal length Dt, the top height Ht, the minimum ground clearance Hg of the trailer 41, and the shape information of the trailer 41 as the form information of the trailer 41. Note that, among the above pieces of information, the dimensional information on the dimensions may be, for example, input in advance by the user or estimated based on the detection information from the range sensor 21 or the imaging device 22. The shape information of the trailer 41 may include, for example, information such as whether the tip (front face) of the trailer 41 has a flat-nose shape or a V-nose shape.

Each of the above pieces of information is a factor that affects the generation of multipath waves due to the trailer 41, and the ECU 30 determines whether to perform the power reduction process based on these pieces of information. The ECU 30 also sets the degree to which the transmission power of the probe waves is reduced in the power reduction process based on these pieces of information.

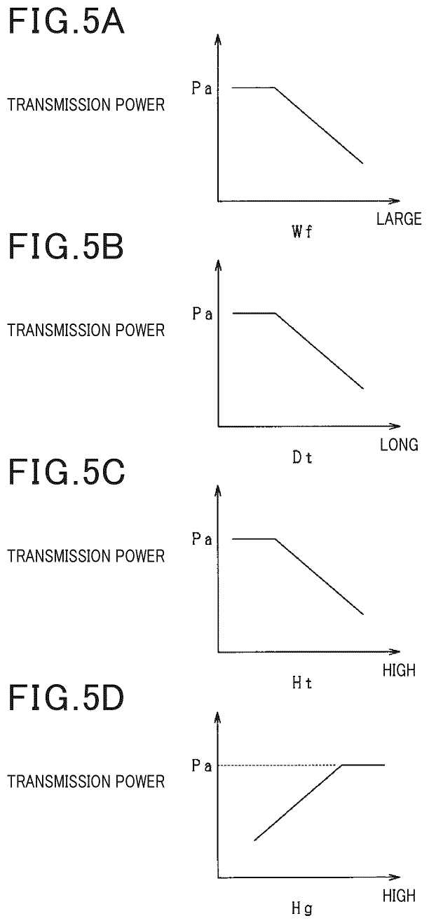

Specifically, when the transmission power of the probe waves is reduced in the power reduction process, the ECU 30 sets the transmission power based on the relationships shown in FIGS. 5A to 5D. Note that, in FIGS. 5A to 5D, the value of the power during normal operation where the trailer 41 is not being towed is denoted by Pa, and the degree to which the transmission power is reduced from the value of the power Pa is shown.

It is considered that the larger the width Wf of the trailer 41, the more likely multipath waves are to be generated. Based on this, in FIG. 5A, the relationship between the width Wf of the trailer 41 and the transmission power is determined so that the larger the width Wf, the smaller the transmission power.

It is considered that the longer the longitudinal length Dt of the trailer 41, the more likely multipath waves are to be generated. Based on this, in FIG. 5B, the relationship between the longitudinal length Dt of the trailer 41 and the transmission power is determined so that the longer the longitudinal length Dt, the smaller the transmission power.

It is considered that the higher the top height Ht of the trailer 41, the more likely multipath waves are to be generated. Based on this, in FIG. 5C, the relationship between the top height Ht of the trailer 41 and the transmission power is determined so that the higher the top height Ht, the smaller the transmission power.

It is considered that the lower the minimum ground clearance Hg of the trailer 41, the more likely multipath waves are to be generated. Based on this, in FIG. 5D, the relationship between the minimum ground clearance Hg of the trailer 41 and the transmission power is determined so that the lower the minimum ground clearance Hg, the smaller the transmission power.

Note that, in FIGS. 5A to 5D, the transmission power may be switched between two values, namely, a normal power value Pa and a power value (≠0) smaller than the power value Pa according to the setting parameter shown by the horizontal axis.

Based on the form information of the trailer 41, the ratio of the area occupied by the trailer 41 to the detection area 70 of the range sensor 21 may be calculated in order to set the transmission power of the probe waves of the range sensor 21 based on this area ratio. In this case, preferably, the larger the ratio of the area occupied by the trailer 41 to the detection area 70 of the range sensor 21, the lower the transmission power is set.

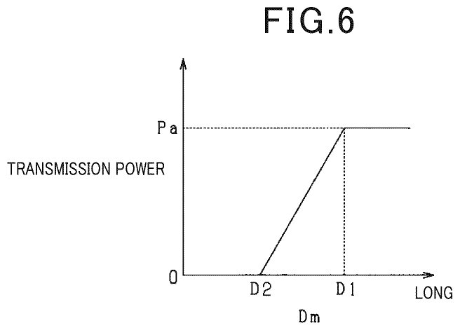

Further, the ECU 30 acquires a distance Dm (see FIG. 3) between the own vehicle 40 and the trailer 41, and sets the degree to which the transmission power of the probe waves is reduced based on the distance Dm. In other words, the ECU 30 estimates the position of the trailer 41 in the longitudinal direction of the own vehicle, and calculates the distance Dm of the trailer 41 from the rear end position of the own vehicle 40. Then, using the relationship shown in FIG. 6, the transmission power of the probe waves is set. In FIG. 6, similarly to FIGS. 5A to 5D, Pa is the power value during normal operation, and the degree to which the transmission power is reduced with respect to the power value Pa is shown.

It is considered that the shorter the distance Dm, the more likely multipath waves are to be received by the range sensor 21. Based on this, in FIG. 6, the relationship between the distance Dm and the transmission power is determined so that the smaller the distance Dm, the smaller the transmission power. In addition, the relationship is set so that, when the distance Dm is larger than a predetermined distance D1, the transmission power is set to the normal power value Pa (power is not reduced), and when the distance Dm is smaller than a predetermined distance D2, the transmission power is set to 0 (probe waves are not transmitted). Note that the transmission power may be switched between two values, namely, the normal power value Pa and a power value (≠0) smaller than the power value Pa according to the distance Dm.

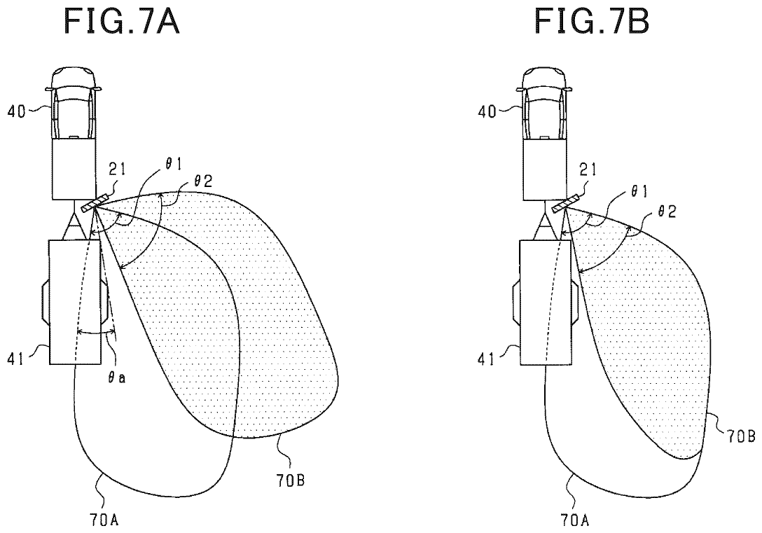

Next, the detection area changing process of the range sensor 21 will be described in detail. FIG. 7A shows, as the detection area 70 of the range sensor 21, a detection area 70A used during normal operation where the trailer 41 is not being towed, and a detection area 70B changed towards the side where the trailer 41 is not present when the trailer is being towed.

In FIG. 7A, regarding an angle θ indicating the scan region of the range sensor 21, the angle during normal operation is set to θ1, and the angle while the trailer is being towed is set to θ2. These angles θ1 and θ2 satisfy θ1=θ2. Therefore, the detection area 70A during normal operation and the detection area 70B while the trailer is being towed have the same size, but the centers of these detection areas 70 extending from the range sensor 21 are different in the vehicle width direction. In other words, the detection area 70B while the trailer is being towed is changed from the detection area 70A during normal operation towards the side where the trailer 41 is not present without changing the scanned region.

However, as shown in FIG. 7B, the angles may be set to satisfy θ1>θ2. In this case, the detection area 70B while the trailer is being towed is changed from the detection area 70A during normal operation towards the side where the trailer 41 is not present by reducing the scanned region.

The ECU 30 may change the detection area 70 of the range sensor 21 based on the above-described form information of the trailer 41. That is, the form of the trailer 41 is a factor that affects the generation of multipath waves due to the trailer 41, and the ECU 30 determines whether to perform the power reduction process based on these pieces of information.

It is also possible to calculate the overlapping region between the detection area 70 of the range sensor 21 and the trailer 41, and change the detection area 70 based on that overlapping region. In this case, the ECU 30 calculates an overlap angle θa indicating a region in the region scanned by the range sensor 21 that overlaps the trailer 41 (see FIG. 7A). The overlap angle θa may be calculated based on the scan region of the range sensor 21, the position at which the range sensor 21 is attached in the own vehicle 40, the width Wf of the trailer 41, the distance Dm, and the shape of the trailer. The ECU 30 changes the detection area 70 of the range sensor 21 in a direction that reduces the overlap angle θa.

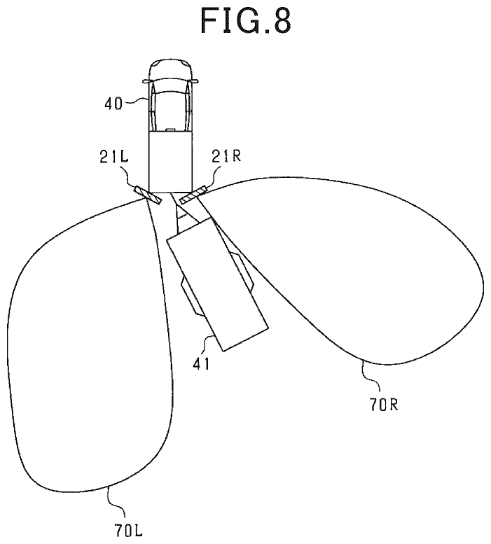

As shown in FIG. 8, when the own vehicle 40 makes a turn while the own vehicle 40 is traveling, the trailer 41 is tilted obliquely with respect to the traveling direction of the own vehicle 40. In this case, the position of the trailer 41 with respect to the detection area 70 of the range sensor 21 will be different from that when the vehicle is traveling straight, and the situation in which multipath waves are generated will also be different. Accordingly, when it is determined that the trailer 41 is being towed by the own vehicle 40 and that the own vehicle 40 is making a turn, the ECU 30 changes how the range sensor 21 detects objects based on the turning state of the own vehicle 40.

The ECU 30 determines whether the own vehicle 40 is making a turn based on at least one of the steering angle information and the yaw rate information of the own vehicle 40. It is also possible to determine whether the own vehicle 40 is making a turn based on the recognition information on road marking lines or map information. When the own vehicle 40 is making a turn, the ECU 30 changes how the range sensor 21 detects objects (transmission power, sensor detection area) in consideration of the fact that the position of the trailer 41 with respect to the detection area 70 of the range sensor 21 changes, in other words, the overlapping region between the detection area 70 of the range sensor 21 and the trailer 41 changes.

The ECU 30 changes how the range sensor 21 detects objects differently on the inner and outer sides of the turning arc of the own vehicle 40. In this case, on the inner side of the turn, the overlapping region between the trailer 41 and the detection area 70 of the range sensor 21 is larger than when the vehicle is traveling straight. Therefore, considering that the influence of multipath waves is greater than when the vehicle is traveling straight, the ECU 30 changes how the range sensor 21 detects objects (transmission power, sensor detection area) so that less multipath waves are received than when the vehicle is traveling straight. At this time, the degree to which the transmission power of the probe waves is reduced, and/or the detection area 70 may be changed depending on the turning radius of the own vehicle 40. Specifically, it is possible that the smaller the turning radius of the own vehicle 40, the smaller the transmission power of the probe waves and/or the smaller the detection area 70.

On the outer side of the turn, the overlapping region between the trailer 41 and the detection area 70 of the range sensor 21 is smaller than when the vehicle is traveling straight. Therefore, in consideration of the fact that the influence of multipath waves is smaller than when the vehicle is traveling straight, the ECU 30 does not suppress the reception of multipath waves as much as when the vehicle is traveling straight. It is also possible to temporarily stop reducing the transmission power of the probe waves or changing (reducing) the detection area 70.

Further, when the own vehicle 40 is making a turn, it may shift its state from traveling straight, turning, and traveling straight in this order. In such as case, the position of the trailer 41 with respect to the detection area 70 of the range sensor 21 changes with time. Therefore, when the own vehicle 40 is making a turn, the ECU 30 carries out the power reduction process and the detection area changing process more frequently than when the vehicle is traveling straight. In other words, when the own vehicle 40 is making a turn, it is preferable that the execution cycles of the power reduction process and the detection area changing process are shorter than when the vehicle is traveling straight. Note that the execution cycles of the power reduction process and the detection area changing process may be changed depending on the traveling speed of the own vehicle 40. It is possible that the higher the traveling speed, the shorter the execution cycle.

FIG. 9 is a flowchart showing a process of changing how the ECU 30 performs sensor detection. This process is repetitively executed at fixed periods.

In step S10, the speed information and turn information of the own vehicle 40 are acquired as information about the own vehicle 40. In step S11, as information about the trailer 41, information indicating whether the trailer 41 is present, the form information of the trailer 41, the position information of the trailer 41, and the detection information from the range sensor 21 and the imaging device 22 are acquired.

In step S12, whether the trailer 41 is coupled to the rear of the own vehicle 40 is determined. If the answer is no in step S12, the process is terminated. In contrast, if the answer is yes in step S12, the control proceeds to step S13. In the present embodiment, step S12 corresponds to a “tow determining unit”.

The power reduction process is performed in step S13. Specifically, as described in FIGS. 5A to 5D, the transmission power of the range sensor 21 is set based on the width Wf, top height Ht, minimum ground clearance Hg, and longitudinal length Dt of the trailer 41. The transmission power of the range sensor 21 is also set based on the distance Dm as described in FIG. 6. In this case, it is preferable to calculate an adjustment coefficient (<1) for each setting parameter and set the degree to which the transmission power is reduced by multiplying each setting parameter by the corresponding adjustment coefficient.

The detection area changing process is performed in step S14. Specifically, as described in FIG. 7A or FIG. 7B, the detection area 70 of the range sensor 21 is changed. The sensor detection area is preferably changed based on the form information of the trailer 41. In the present embodiment, steps S13 and S14 correspond to a “changing unit”.

Preferably, in step S14, it is determined whether the own vehicle 40 is making a turn, and if it is, how the range sensor 21 detects objects is changed based on the estimated position of the trailer 41 while the own vehicle 40 is making a turn. In this case, the ECU 30 changes how the range sensor 21 detects objects differently on the inner and outer sides of the turning arc of the own vehicle 40. Specifically, the transmission power and the detection area 70 of the range sensor 21 are changed so that less multipath waves are received on the inner side of the turn than when the vehicle is traveling straight. The transmission power and the detection area 70 of the range sensor 21 are changed so that, on the outer side of the turn, the reception of multipath waves is not suppressed as much as when the vehicle is traveling straight. It is preferable that the transmission power and the detection area 70, which are set based on the form information of the trailer 41 and the like, are adjusted according to the turning state of the own vehicle 40.

Note that, in the process of FIG. 9, when the own vehicle 40 is making a turn, the power reduction process and the detection area changing process may be performed more frequently than when the vehicle is traveling straight.

According to the present embodiment described above in detail, the following effects can be obtained.

If it is determined that the trailer 41 is coupled to the rear of the own vehicle 40, how the range sensor 21 detects objects is changed to suppress reception of reflected waves caused by the presence of the trailer 41. This suppresses the reception of multipath waves, which are reflected waves unnecessary for detecting objects when objects behind the own vehicle 40 are to be recognized. As a result, in a situation where the trailer 41 is coupled to the rear of the own vehicle 40, objects behind the own vehicle 40 can be correctly recognized.

When the trailer 41 is being towed, how the range sensor 21 detects objects is changed by reducing the transmission power of the probe waves transmitted from the range sensor 21. In this case, by reducing the transmission power of the probe waves, it is possible to prevent multipath waves from being recognized as reflected waves from an object even if multipath waves are generated due to the trailer. This allows suppression of false recognition of objects due to multipath waves.

When the trailer 41 is being towed, how the range sensor 21 detects objects is changed by changing the detection area 70 of the range sensor 21 towards the side where the trailer 41 is not present. In this case, it is possible to reduce the generation of multipath waves due to the trailer by changing the detection area 70 of the range sensor 21. This allows suppression of false recognition of objects due to multipath waves.

The form information on the form of the trailer 41 is acquired, and how the range sensor 21 detects objects is changed based on this form information. In this case, how the range sensor 21 detects objects can be appropriately set taking into consideration the fact that the generation of multipath waves differs depending on the form of the trailer 41.

The degree to which the transmission power of the probe waves is reduced is set based on the distance Dm between the own vehicle 40 and the trailer 41. This makes it possible to appropriately set the transmission power of the probe waves in the range sensor 21.

If it is determined that a trailer is being towed and the own vehicle 40 is making a turn, how the range sensor 21 detects objects is changed based on the turning state of the own vehicle 40. In this case, when the own vehicle 40 is making a turn, how the range sensor 21 detects objects can be appropriately changed taking into consideration the fact that the position of the trailer 41 with respect to the detection area 70 of the range sensor 21 differs from when the own vehicle 40 is traveling straight. This makes it possible to appropriately recognize objects even when the own vehicle 40 turns while towing a trailer.

Other embodiments will be described with reference to drawings, mainly focusing on the differences with the first embodiment.

### Second Embodiment

When the trailer 41 is being towed behind the own vehicle 40, it is possible to determine how much multipath waves are actually being generated based on the reception power of the reflected waves received by the range sensor 21 from the direction in which the trailer 41 is present. In other words, if the reception power of the reflected waves by the range sensor 21 from the direction in which the trailer 41 is present is relatively large, it can be determined that the trailer 41 behind the own vehicle is actually the cause of the generation of multipath waves. Therefore, in this embodiment, the reception power of the reflected waves received by the range sensor 21 from the direction in which the trailer 41 is present is calculated, and how the range sensor 21 detects objects is changed based on the reception power.

Specifically, in the power reduction process of step S13 in FIG. 9, the ECU 30 calculates the reception power of the reflected waves received by the range sensor 21, and the larger the reception power, the larger the degree to which the transmission power of the probe waves is reduced (that is, the smaller the transmission power). It is also possible to arrange the detection area changing process of step S14 so that the larger the reception power of the reflected waves received by the range sensor 21, the more the sensor detection area is changed towards the side opposite to the trailer, or the smaller the sensor detection area.

According to the configuration of the present embodiment, it is possible to perform appropriate object recognition in accordance with how much multipath waves are actually generated when a trailer is being towed.

### Third Embodiment

As shown in FIG. 10, when the trailer 41 is being towed behind the own vehicle 40, a plurality of multipath waves are generated, and the ECU 30 recognizes a plurality of dummy objects. In FIG. 10, the objects recognized in a range X behind the own vehicle 40 include a plurality of dummy objects. In this case, the dummy objects are recognized in the direction of the trailer 41, and if the number of dummy objects is large, it can be determined that a plurality of multipath waves are actually generated. Therefore, in this embodiment, the number of objects (number of dummy objects) recognized by the reflected waves received by the range sensor 21 from the direction of the trailer 41 is calculated, and how the range sensor 21 detects objects is changed based on the number of objects.

Specifically, in the detection area changing process of step S14 in FIG. 9, the ECU 30 calculates the number of dummy objects recognized by the reflected waves received by the range sensor 21 from the direction of the trailer 41. The more the number of dummy objects, the more the detection area 70 of the range sensor 21 is changed towards the side opposite to the trailer, or the smaller the detection area 70. It is also possible to change the detection area 70 of the range sensor 21 based on the ratio of the number of dummy objects to the total number of objects.

The power reduction process of step S13 may also be arranged so that the larger the number of objects recognized by the reflected waves received by the range sensor 21 from the direction of the trailer 41, the larger the degree to which the transmission power of the probe waves is reduced, that is, the smaller the transmission power.

According to the configuration of the present embodiment, it is possible to perform appropriate object recognition in accordance with how much multipath waves are actually generated when a trailer is being towed.

### Fourth Embodiment

In this embodiment, the conditions for performing the power reduction process and the detection area changing process are changed. That is, the reception power of the reflected waves received by the range sensor 21 from the direction of the trailer 41 is calculated, and the power reduction process is performed if the reception power is larger than a predetermined power. Further, the number of objects recognized by the reflected waves received by the range sensor 21 from the direction of the trailer 41 is calculated, and the detection area changing process is performed if the number of objects is larger than a predetermined number.

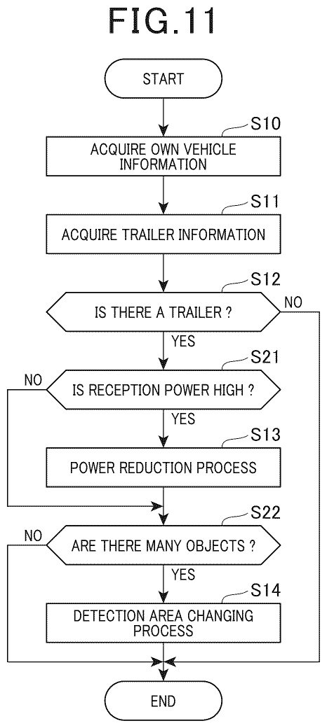

Specifically, the ECU 30 performs the process shown in FIG. 11. Note that the process in FIG. 11 is a partial modification of the process in FIG. 9, and identical steps are given the same step numbers and will not be explained.

In FIG. 11, in step S21, the reception power of the reflected waves received by the range sensor 21 from the direction of the trailer 41 is calculated, and whether the reception power is larger than a predetermined power is determined. If the answer is yes in step S21, the control proceeds to step S13, and the power reduction process is performed.

Further, in step S22, the number of objects (dummy objects) recognized by the reflected waves received by the range sensor 21 from the direction of the trailer 41 is calculated, and whether the number of objects is larger than a predetermined number is determined. If the answer is yes in step S22, the control proceeds to step S14, and the detection area changing process is performed.

In the power reduction process in step S13, the degree to which the transmission power of the probe waves is reduced may be set based on the reception power of the reflected waves received by the range sensor 21 from the direction of the trailer 41. In this case, the larger the reception power of the reflected waves, the larger the degree to which the transmission power of the probe waves is reduced (that is, the smaller the transmission power).

According to the configuration of the present embodiment, it is possible to perform the power reduction process and the detection area changing process moderately in accordance with how much multipath waves are actually generated. In other words, if the power reduction process or detection area change process is performed excessively, the accuracy of recognition of other vehicles or other targets that should actually be recognized may decrease. By performing these power reduction process and detection area changing process moderately, it is possible to appropriately recognize objects such as other vehicles.

### Other Embodiments

The above-described embodiments may be changed and implemented in the following manner.
When reflected waves from an area that is within the detection area 70 of the range sensor 21 and does not overlap with the trailer 41, the power reduction process and detection area changing process may be performed based on the reception power of the reflected waves. Specifically, when an object to be recognized is properly detected within the detection area 70 of the range sensor 21 by reflected waves from that object (another vehicle or the like), the ECU 30 limits the execution of the power reduction process or the detection area changing process if the reception power of the reflected waves from the object is smaller than a predetermined power. In such a case, to limit the execution of the power reduction process or the detection area changing process, the degree to which the reception of multipath waves is suppressed may be reduced in the power reduction process or the detection area change process, or the execution of the power reduction process or the detection area change process may be stopped. This prevents the detection performance for the objects that should actually be recognized from decreasing excessively.
Vehicle control apparatuses and methods thereof described in the present disclosure may be implemented by a dedicated computer provided by configuring a processor and memory programmed to perform one or more functions embodied by a computer program. Alternatively, vehicle control apparatuses and methods thereof described in this present disclosure may be implemented by a dedicated computer provided by configuring a processor with one or more dedicated hardware logic circuits. Alternatively, vehicle control apparatuses and methods thereof described in the present disclosure may be implemented by one or more dedicated computers configured by combining a processor and memory programmed to perform one or more functions with a processor including one or more hardware logic circuits. The computer program may be stored in a tangible computer-readable non-transitory memory medium as instructions to be executed by a computer.

The present disclosure has been described in accordance with the embodiment, but the present disclosure should in no way be construed as being limited to the embodiment, the configuration, and the like. The present disclosure includes many variations, and modifications within the range of equivalency. In addition to various combinations and forms, other combinations and forms including one or more/less elements thereof are also within the spirit and scope of the present disclosure.

Characteristic configurations extracted from the embodiments described above will be described below.

### Configuration 1

An object recognition device (30) applied to a vehicle having a range sensor (21) that transmits a probe wave and receives a reflected wave of the probe wave and configured to recognize an object behind an own vehicle (40) based on detection information of the range sensor, the object recognition device comprising:
a tow determining unit configured to determine whether a towed vehicle (41) is coupled to a rear of the own vehicle; and
a changing unit configured to, in response to determining that the towed vehicle is coupled to the rear of the own vehicle, change how the range sensor detects an object to suppress reception of the reflected wave caused by presence of the towed vehicle.

### Configuration 2

The object recognition device according to configuration 1, wherein the changing unit is configured to, in response to determining that the towed vehicle is coupled to the rear of the own vehicle, change how the range sensor detects an object by reducing transmission power of the probe wave transmitted from the range sensor.

### Configuration 3

The object recognition device according to configuration 1 or 2, wherein the changing unit is configured to, in response to determining that the towed vehicle is coupled to the rear of the own vehicle, change how the range sensor detects an object by changing a detection area of the range sensor towards a side where the towed vehicle is not present.

### Configuration 4

The object recognition device according to any one of configurations 1 to 3, further comprising a power calculation unit configured to calculate reception power of the reflected wave received by the range sensor from a direction in which the towed vehicle is present,
wherein the changing unit is configured to, in response to determining that the towed vehicle is coupled to the rear of the own vehicle, change how the range sensor detects an object based on the reception power calculated by the power calculation unit.

### Configuration 5

The object recognition device according to any one of configurations 1 to 4, further comprising an object number calculation unit configured to calculate a number of an object recognized by the reflected wave received by the range sensor from a direction in which the towed vehicle is present,
wherein the changing unit is configured to, in response to determining that the towed vehicle is coupled to the rear of the own vehicle, change how the range sensor detects an object based on the number of the object calculated by the object number calculation unit.

### Configuration 6

The object recognition device according to configuration 1, further comprising a power calculation unit configured to calculate reception power of the reflected wave received by the range sensor from a direction in which the towed vehicle is present,
wherein the changing unit is configured to:
change how the range sensor detects an object by reducing transmission power of the probe wave transmitted from the range sensor, and
in response to determining that the towed vehicle is coupled to the rear of the own vehicle, perform a process that reduces the transmission power of the probe wave on condition that the reception power calculated by the power calculation unit is larger than a predetermined power.

### Configuration 7

The object recognition device according to configuration 6, wherein the changing unit is configured to, in response to determining that the towed vehicle is coupled to the rear of the own vehicle, set a degree to which transmission power of the probe wave is reduced based on the reception power calculated by the power calculation unit.

### Configuration 8

The object recognition device according to any one of configurations 2, 6, and 7, further comprising a distance acquisition unit configured to acquire a distance between the own vehicle and the towed vehicle,
wherein the changing unit is configured to, in response to determining that the towed vehicle is coupled to the rear of the own vehicle, set a degree to which the transmission power of the probe wave is reduced based on the distance.

### Configuration 9

The object recognition device according to any one of configurations 1 and 6 to 8, further comprising an object number calculation unit configured to calculate a number of an object recognized by the reflected wave received by the range sensor from a direction in which the towed vehicle is present,
wherein the changing unit is configured to:
change how the range sensor detects an object by changing a detection area of the range sensor towards a side where the towed vehicle is not present, and
in response to determining that the towed vehicle is coupled to the rear of the own vehicle, change the detection area of the range sensor towards the side where the towed vehicle is not present on condition that the number of the object calculated by the object number calculation unit is larger than a predetermined number.

### Configuration 10

The object recognition device according to any one of configurations 1 to 9, further comprising a form information acquisition unit configured to acquire form information on a form of the towed vehicle,
wherein the changing unit is configured to change how the range sensor detects an object based on the acquired form information.

### Configuration 11

The object recognition device according to any one of configurations 1 to 10, further comprising a turn determining unit configured to determine whether the own vehicle is making a turn,
wherein the changing unit is configured to, in response to determining that the towed vehicle is coupled to the rear of the own vehicle and the own vehicle is making a turn, change how the range sensor detects an object based on a turning state of the own vehicle.

What is claimed is:

1. An object recognition device applied to a vehicle having a range sensor that transmits a probe wave and receives a reflected wave of the probe wave and configured to recognize an object behind an own vehicle based on detection information of the range sensor, the object recognition device comprising:
a tow determining unit configured to determine whether a towed vehicle is coupled to a rear of the own vehicle; and
a changing unit configured to, in response to determining that the towed vehicle is coupled to the rear of the own vehicle, change how the range sensor detects an object to suppress reception of the reflected wave caused by presence of the towed vehicle.

2. The object recognition device according to claim 1, wherein the changing unit is configured to, in response to determining that the towed vehicle is coupled to the rear of the own vehicle, change how the range sensor detects an object by reducing transmission power of the probe wave transmitted from the range sensor.

3. The object recognition device according to claim 1, wherein the changing unit is configured to, in response to determining that the towed vehicle is coupled to the rear of the own vehicle, change how the range sensor detects an object by changing a detection area of the range sensor towards a side where the towed vehicle is not present.

4. The object recognition device according to claim 1, further comprising a power calculation unit configured to calculate reception power of the reflected wave received by the range sensor from a direction in which the towed vehicle is present,
wherein the changing unit is configured to, in response to determining that the towed vehicle is coupled to the rear of the own vehicle, change how the range sensor detects an object based on the reception power calculated by the power calculation unit.

5. The object recognition device according to claim 1, further comprising an object number calculation unit configured to calculate a number of an object recognized by the reflected wave received by the range sensor from a direction in which the towed vehicle is present,
wherein the changing unit is configured to, in response to determining that the towed vehicle is coupled to the rear of the own vehicle, change how the range sensor detects an object based on the number of the object calculated by the object number calculation unit.

6. The object recognition device according to claim 1, further comprising a power calculation unit configured to calculate reception power of the reflected wave received by the range sensor from a direction in which the towed vehicle is present,
wherein the changing unit is configured to:
change how the range sensor detects an object by reducing transmission power of the probe wave transmitted from the range sensor, and
in response to determining that the towed vehicle is coupled to the rear of the own vehicle, perform a process that reduces the transmission power of the probe wave on condition that the reception power calculated by the power calculation unit is larger than a predetermined power.

7. The object recognition device according to claim 6, wherein the changing unit is configured to, in response to determining that the towed vehicle is coupled to the rear of the own vehicle, set a degree to which transmission power of the probe wave is reduced based on the reception power calculated by the power calculation unit.

8. The object recognition device according to claim 2, further comprising a distance acquisition unit configured to acquire a distance between the own vehicle and the towed vehicle,
wherein the changing unit is configured to, in response to determining that the towed vehicle is coupled to the rear of the own vehicle, set a degree to which the transmission power of the probe wave is reduced based on the distance.

9. The object recognition device according to claim 1, further comprising an object number calculation unit configured to calculate a number of an object recognized by the reflected wave received by the range sensor from a direction in which the towed vehicle is present,
wherein the changing unit is configured to:
change how the range sensor detects an object by changing a detection area of the range sensor towards a side where the towed vehicle is not present, and
in response to determining that the towed vehicle is coupled to the rear of the own vehicle, change the detection area of the range sensor towards the side where the towed vehicle is not present on condition that the number of the object calculated by the object number calculation unit is larger than a predetermined number.

10. The object recognition device according to claim 1, further comprising a form information acquisition unit configured to acquire form information on a form of the towed vehicle,
wherein the changing unit is configured to change how the range sensor detects an object based on the acquired form information.

11. The object recognition device according to claim 1, further comprising a turn determining unit configured to determine whether the own vehicle is making a turn,
wherein the changing unit is configured to, in response to determining that the towed vehicle is coupled to the rear of the own vehicle and the own vehicle is making a turn, change how the range sensor detects an object based on a turning state of the own vehicle.

12. The object recognition device according to claim 6, further comprising a distance acquisition unit configured to acquire a distance between the own vehicle and the towed vehicle,
wherein the changing unit is configured to, in response to determining that the towed vehicle is coupled to the rear of the own vehicle, set a degree to which the transmission power of the probe wave is reduced based on the distance.

13. A program applied to a vehicle having a range sensor that transmits a probe wave and receives a reflected wave of the probe wave and executed by a controller to recognize an object behind an own vehicle based on detection information of the range sensor, the program including:
a tow determining step of determining whether a towed vehicle is coupled to a rear of the own vehicle; and
a changing step of, in response to determining that the towed vehicle is coupled to the rear of the own vehicle, changing how the range sensor detects an object to suppress reception of the reflected wave caused by presence of the towed vehicle.
